(19) United States
(12) Patent Application Publication
(10) Pub. No.: US 2012/0103964 A1
(43) Pub. Date: May 3, 2012

(54) HEATING DEVICE FOR CUTTING TOOLS

(76) Inventor: Chin-Duey CHEN, Qingshui Township (TW)

(21) Appl. No.: 12/938,065

(22) Filed: Nov. 2, 2010

(51) Int. Cl. H05B 1/00

(52) U.S. Cl. 219/221

(57) ABSTRACT

A heating device for cutting tools has an outer casing, a power source, a cover board, a magnetizer and two conductive coils. The outer casing has an opening. The cover board is mounted securely on the top of the outer casing to cover the opening and has two through holes communicating with the opening. The magnetizer is mounted in the outer casing and has a conducting body. The conducting body is mounted in the outer casing, extends in the through holes of the cover board via the opening and has a middle and two free ends respectively extending in the through holes of the cover board. The conductive coils are respectively mounted around the free ends of the conducting body, abut the cover board and are electrically connected to the power source of the outer casing.

### BACKGROUND OF THE INVENTION

1. Field of the Invention

The present invention relates to a heating device, and more particularly to a heating device for cutting tools to heat the cutting tools conveniently.

2. Description of Related Art

A cutting tool has a tool shaft and a collet. Before the tool shaft of the cutting tool being mounted securely in the collet, the collet is heated by a conventional heating device to make a shaft hole of the collet slightly expand to allow the tool shaft to be inserted into the shaft hole. However, the conventional heating device is not convenient in use.

Therefore, the present invention provides a heating device for cutting tools to mitigate or obviate the aforementioned problems.

### SUMMARY OF THE INVENTION

The main objective of the present invention is to provide a heating device for cutting tools that can heat the cutting tools conveniently.

The heating device for cutting tools in accordance with the present invention has an outer casing, a power source, a cover board, a magnetizer and two conductive coils. The outer casing has an opening. The cover board is mounted securely on the top of the outer casing to cover the opening and has two through holes communicating with the opening. The magnetizer is mounted in the outer casing and has a conducting body. The conducting body is mounted in the outer casing, extends in the through holes of the cover board via the opening and has a middle and two free ends respectively extending in the through holes of the cover board. The conductive coils are respectively mounted around the conducting body of the magnetizer at the free ends of the conducting body, abut the cover board and are electrically connected to the power source of the outer casing.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view in partial section of a first embodiment of a heating device for cutting tools in accordance with the present invention;

FIG. 2 is an enlarged side view in partial section of the heating device in FIG. 1;

FIG. 3 is an enlarged perspective view of a magnetizer and two conductive coils of the heating device in FIG. 1;

FIG. 4 is a perspective view of a second embodiment of a heating device for cutting tools in accordance with the present invention; and

FIG. 5 is a perspective view of a third embodiment of a heating device for cutting tools in accordance with the present invention.

### DETAILED DESCRIPTION OF THE PREFERRED EMBODIMENT

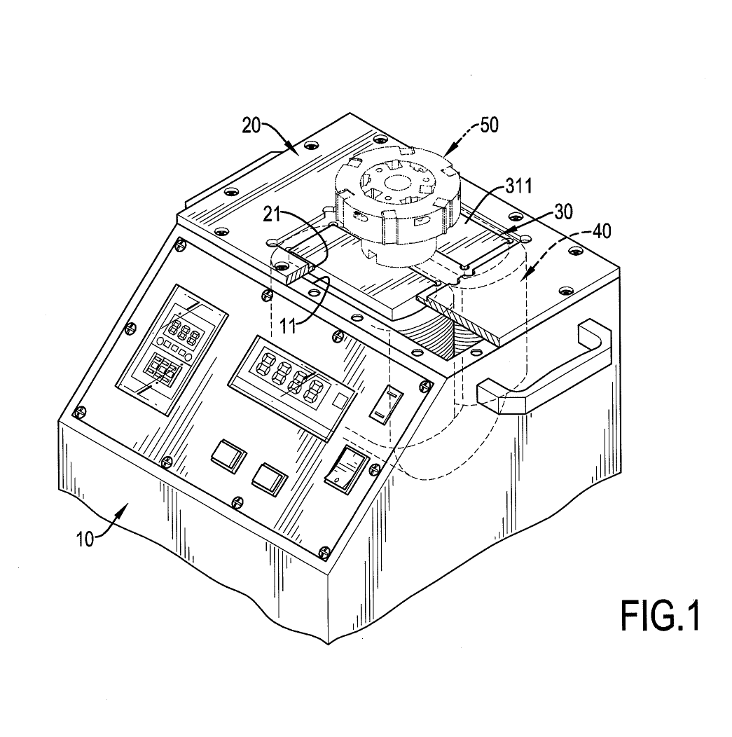

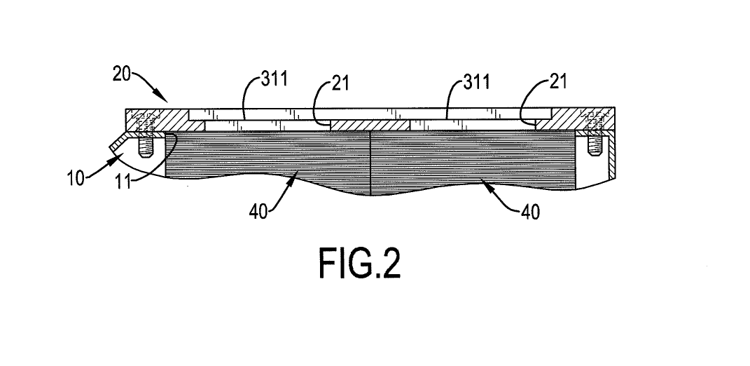

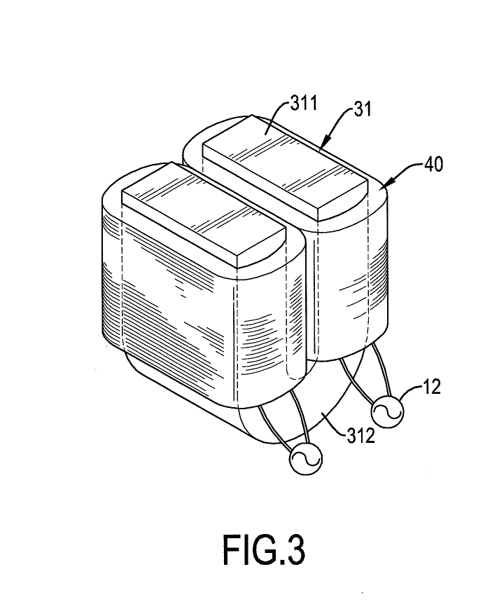

With reference to FIGS. 1 to 3, a heating device for cutting tools 50 in accordance with the present invention comprises an outer casing 10, a power source 12, a cover board 20, a magnetizer 30 and two conductive coils 40.

The outer casing 10 is hollow and has a top and an opening 11. The opening 11 is formed through the top of the outer casing 10.

The power source 12 is mounted in the outer casing 10 to supply an alternating current.

The cover board 20 may be made of insulation materials (such as bakelite), is mounted securely on the top of the outer casing 10 to cover the opening 11 of the outer casing 10 and has a top, a bottom, a flat surface and two through holes 21. The flat surface may be rectangular and is formed on the top of the cover board 20. The through holes 21 are formed through the flat surface of the cover board 20 at an interval and communicate with the opening 11 of the outer casing 10.

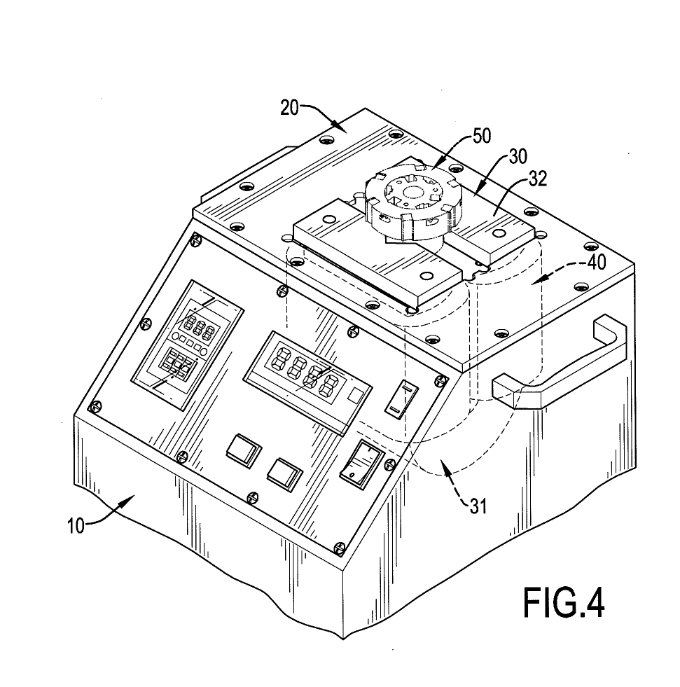

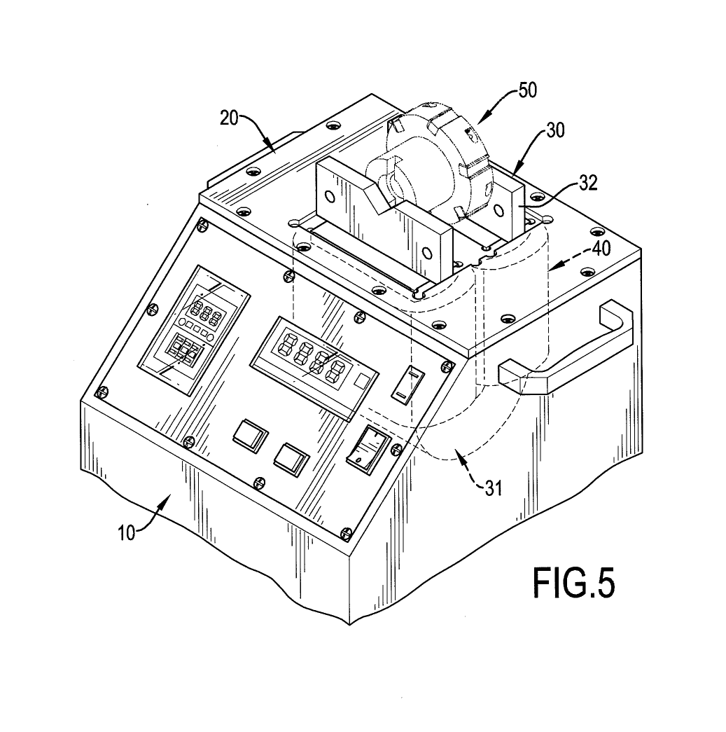

The magnetizer 30 is mounted in the outer casing 10 and has a conducting body 31 and two conducting elements 32 as shown in FIGS. 4 and 5. The conducting body 31 may be U-shaped, is mounted in the outer casing 10, extends in the through holes 21 of the cover board 20 via the opening 11 of the. outer casing 10 and has a middle 312 and two free ends 311. Furthermore, the conducting body 31 may be made of metallic materials with high magnetic permeability. The middle 312 of the conducting body 31 is mounted in the outer casing 10. The free ends 311 of the conducting body 31 are formed on and protrude from the middle 312 of the conducting body 31, respectively extend in the through holes 21 of the cover board 20 and each free end 311 of the conducting body 31 has an outer face. The outer faces of the free ends 311 of the conducting body 31 are flush with the flat surface of the cover board 20.

With reference to FIGS. 4 and 5, the conducting elements 32 may be sheets, are respectively mounted on the free ends 311 of the conducting body 31 to hold a cutting tool 50 securely on the magnetizer 30 and each conducting element 32 has a surface and a side connected to the surface. The surface of the conducting element 32 has an area. The side of the conducting element 32 has an area smaller than that of the surface of the conducting element 32. The surfaces of the conducting elements 32 may respectively abut the outer faces of the free ends 311 of the conducting body 31 as shown in FIG. 4 or the sides of the conducting elements 32 are respectively mounted on the outer faces of the free ends 311 of the conducting body 31 at right angles relative to the outer faces of the free ends 311 of the conducting body 31 as shown in FIG. 5.

The conductive coils 40 are mounted around the conducting body 31 of the magnetizer 30 respectively near the free ends 311 of the conducting body 31, abut the bottom of the cover board 20 and are electrically connected to the power source 12 of the outer casing 10.

In operation, a cutting tool 50 is mounted on the free ends 311 of the conducting body 31 as shown in FIG. 1 or may be securely held between the conducting elements 32 as shown in FIGS. 4 and 5 to allow the cutting tool 50 to mount securely on the free ends 311 of the conducting body 31. When the alternating current is imported into the conductive coils 40 from the power source 12 of the outer casing 10, the conducting body 31 of the magnetizer 30 will be induced to form multiple magnetic lines between the free ends 311 of the conducting body 31 through electromagnetic induction. When the magnetic lines are formed between the free ends 311 of the conducting body 31, the magnetic lines will pass through the cutting tool 50 to form heat energy to the cutting tool 50. Thus, the cutting tool 50 can be heated conveniently by mounting the cutting tool 50 on the free ends 311 of the conducting body 31 and turning on the power source 12 of the outer casing 10. In addition, the conducting elements 32 that hold the cutting tool 50 can increase the amount of the magnetic lines to pass through the cutting tool 50 and this can shorten the heating time of heating the cutting tool 50 to enhance the heating efficiency of the heating device in accordance with the present invention.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A heating device for cutting tools comprising:
an outer casing being hollow and having
a top; and
an opening formed through the top of the outer casing;
a power source mounted in the outer casing to supply an alternating current;
a cover board mounted securely on the top of the outer casing to cover the opening of the outer casing and having
a top;
a bottom;
a flat surface formed on the top of the cover board; and
two through holes formed through the flat surface of the cover board at an interval and communicating with the opening of the outer casing;
a magnetizer mounted in the outer casing and having
a conducting body mounted in the outer casing, extending in the through holes of the cover board via the opening of the outer casing and having
a middle mounted in the outer casing; and
two free ends formed on and protruding from the middle of the conducting body, respectively extending in the through holes of the cover board and each free end has an outer face being flush with the flat surface of the cover board; and
two conductive coils mounted around the conducting body of the magnetizer respectively near the free ends of the conducting body, abutting the cover board and electrically connected to the power source of the outer casing.

2. The heating device for cutting tools as claimed in claim 1, wherein the magnetizer has two conducting elements respectively mounted on the free ends of the conducting body to hold a cutting tool securely on the magnetizer.

3. The heating device for cutting tools as claimed in claim 2, wherein the conducting elements are sheets and each conducting element has
a side having an area; and
a surface connected to the side of the conducting element, having an area larger than the area of the side of the conducting element and abutting one of the free ends of the conducting body to hold a cutting tool.

4. The heating device for cutting tools as claimed in claim 2, wherein the conducting elements are sheets and each conducting element has
a surface having an area; and
a side connected to the surface of the conducting element, having an area smaller than the area of the surface of the conducting element and mounted on the outer face of one of the free ends of the conducting body at a right angle relative to the outer face of the corresponding free end of the conducting body to hold a cutting tool.

5. The heating device for cutting tools as claimed in claim 1, wherein the conducting body is U-shaped.

6. The heating device for cutting tools as claimed in claim 2, wherein the conducting body is U-shaped.

7. The heating device for cutting tools as claimed in claim 3, wherein the conducting body is U-shaped.

8. The heating device for cutting tools as claimed in claim 4, wherein the conducting body is U-shaped.
